(19) United States
(12) Patent Application Publication
(10) Pub. No.: US 2009/0255225 A1
(43) Pub. Date: Oct. 15, 2009

(54) AIR FILTRATION SYSTEM

(75) Inventor: James R. Dralle, Lemont, IL (US)

Correspondence Address: HOLLAND & KNIGHT LLP, 10 ST. JAMES AVENUE, BOSTON, MA, 02116-3889, US

(73) Assignee: A. J. Dralle, Inc., Joliet, IL (US)

(21) Appl. No.: 12/103,407

(22) Filed: Apr. 15, 2008

(51) Int. Cl. B01D 46/42

(52) U.S. Cl. 55/379

(57) ABSTRACT

A bag filter system including a filter media insert including a plurality of pockets. A tuck frame may be configured for mounting in a support frame of a filtration system. The tuck frame may be further configured to releasably engage at least a portion of the filter media insert. A wire frame may be disposed at least partially within the tuck frame. The wire frame may be configured to support the plurality of pockets of the filter media insert.

### FIELD OF THE INVENTION

The present disclosure relates to air filtration systems, and more specifically to bag filter systems.

### BACKGROUND

Environmental awareness and protection efforts have led to many changes in the air filtration industries. For example, internal air quality in buildings is often regulated by state and federal authorities to improve air quality and the efficiency with which it is filtered. Similarly, the painting industry must filter the exhaust air in paint booths to remove particulates and volatile organic compounds in the paint formulations from the paint overspray. Both heating, ventilation and air conditioning systems and paint overspray collection systems may utilize multiple filtration stages including bag filters due to the bag filters' increased surface area over flat filter media. Environmental Protection Agency (EPA) Method 319 describes minimum filter efficiencies for specific micron and sub-micron particle sizes and mandates a three-stage exhaust system for aerospace painting and reworking facilities.

In paint overspray filtration systems, the filtration media often must be disposed of as a hazardous waste due to hazardous compounds and particulates present in the paint formulations, such as chromate, which are deposited in the filters. Disposable bag filters often include a built-in wire and/or metal header supports, such as those utilized in paint overspray collection systems. The built-in wire and/or metal header support may contribute as much as three pounds to the weight of the bag filter and such supports are disposed of with the bag filter as hazardous waste, increasing the cost of disposal and resulting in tons of hazardous waste each year. Thus, there exists a need for a bag filter system that is removable from the wire and metal header supports for disposal.

### SUMMARY

In an embodiment, a bag filter system includes a filter media insert including a plurality of pockets. A tuck frame may be configured for mounting in a support frame of a filtration system. The tuck frame may be further configured to releasably engage at least a portion of the filter media insert. A wire frame may be disposed at least partially within the tuck frame. The wire frame may be configured to support the plurality of pockets of the filter media insert.

One or more of the following features may be included. A hem seal may be attached to a perimeter of the filter media insert. The hem seal may be configured for releasable engagement with the tuck frame. The tuck frame may include a first channel configured to accept the hem seal and a second channel configured to accept the wire frame. The hem seal may be configured to form a seal with the tuck frame. The hem seal may be stitched to the filter media insert. The hem seal may be hemmed into the filter media insert. The hem seal may be configured to collapse to facilitate the releasable engagement of the hem seal with the tuck frame, the hem seal returning to an uncollapsed configuration once engaged in the tuck frame.

The tuck frame may be mounted in the support frame of the filtration system by an adhesive. A sealing mechanism may be configured to provide a seal between the tuck frame and the support frame. The sealing mechanism may be an adhesive member. The tuck frame may be releasably mounted in the support frame of the filtration system.

The filter media insert may be disposable. The bag filter system may be configured for use in one or more of a paint overspray collection system, a heating system, a ventilation system, and an air conditioning system. The tuck frame may be one or more of reusable and replaceable. The tuck frame may be formed by extrusion.

The bag filter system may be implemented to realize one or more of the following advantages. For example, the releasable engagement of the filter media insert in the tuck frame may enable disposal of the filter media insert separate from the tuck frame and wire frame assembly, reducing the amount of hazardous material disposed. Similarly, the reusable tuck frame may reduce the amount of materials and steps required for manufacturing the bag filter systems, reducing the cost of production.

The details of one or more embodiments are set forth in the accompanying drawings and the description below. Other features and advantages will become apparent from the description, the drawings, and the claims.

### BRIEF DESCRIPTION OF THE DRAWINGS

FIG. 1 is a cross-sectional cut-away view of a bag filter system.

FIG. 2 is a perspective view of a tuck frame of the bag filter system of FIG. 1.

FIG. 3 is a top view of a tuck frame and wire frame of the bag filter system of FIG. 1.

FIG. 4 is a cross-sectional view of a hem seal of the bag filter system of FIG. 1.

FIG. 5 is a cross-sectional view of an alternative embodiment of the hem seal of the bag filter system of FIG. 1.

Like reference numbers and designations in the various drawings indicate like elements.

### DETAILED DESCRIPTION

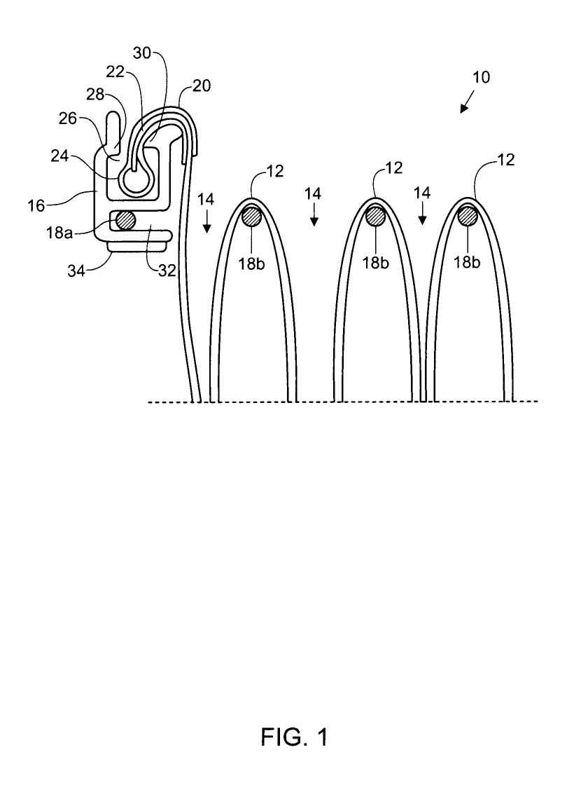

As seen in FIG. 1, an exemplary bag filter system 10 may include a filter media insert 12 including a plurality of pockets 14. The filter media insert 12 may be constructed of any suitable materials, such as polyester, that meet the applicable Environmental Protection Agency regulations, such as EPA Method 319 for Aerospace Manufacturing and Reworking Facilities. The materials, structure and nature of the filter media insert 12 may be varied to suit various desired applications. For example, the filter media insert 12 may be constructed from one or more paper membranes including cellulose fibers, as well as other fiber and porous media structures. The filter media insert 12 may be constructed such that the media material forms the plurality of bags or pockets 14, rather than a flat media insert construction, thereby increasing the amount of surface area for particulate collection. The filter media insert 12 may be disposable, for example, pursuant to any relevant regulations for the use of the filter media insert 12.

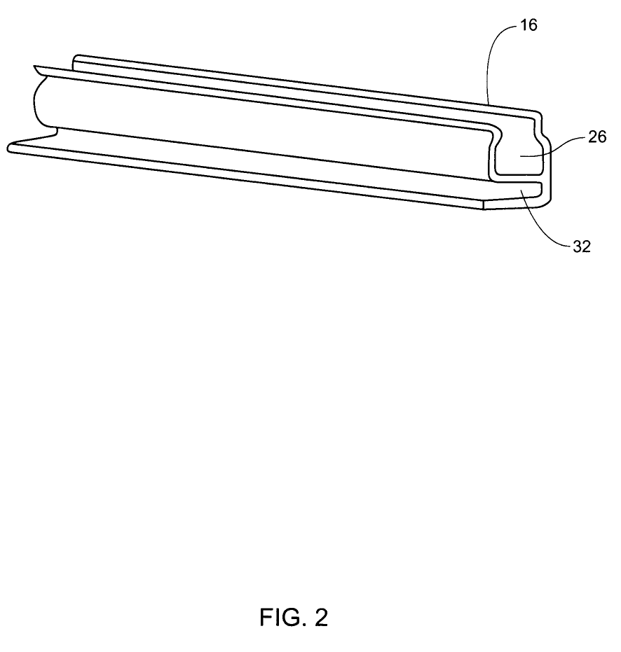

Referring also to FIG. 2, a tuck frame 16 may be configured for mounting in a support frame (not shown) of a filtration system. The tuck frame 16 may be formed by any suitable means or of any suitable material. For example, the tuck frame 16 may be formed from an extruded or molded plastic, such as rigid polyvinyl chloride (PVC), or other suitable material of sufficient strength, to hold the bag filter system 10 in place in a filtration system, and may be constructed to fit in existing filtration systems, such as paint overspray systems and/or heating, ventilation and/or air conditioning systems. The tuck frame 16 may be further configured to releasably engage at least a portion of the filter media insert 12. For example, an edge or perimeter 22 of the filter media insert 12 may be configured to be inserted or tucked into and held by the tuck frame 16, for example, by pressing the perimeter or edge 22 of the filter media insert 12 into a receptacle in the tuck frame 16 (e.g., channel 26) where it is held in place by friction fit with the tuck frame 16. The filter media insert 12 may be inserted into the tuck frame 16 for use in particulate collection/filtration and may be removed and disposed of once its useful capacity has been fulfilled.

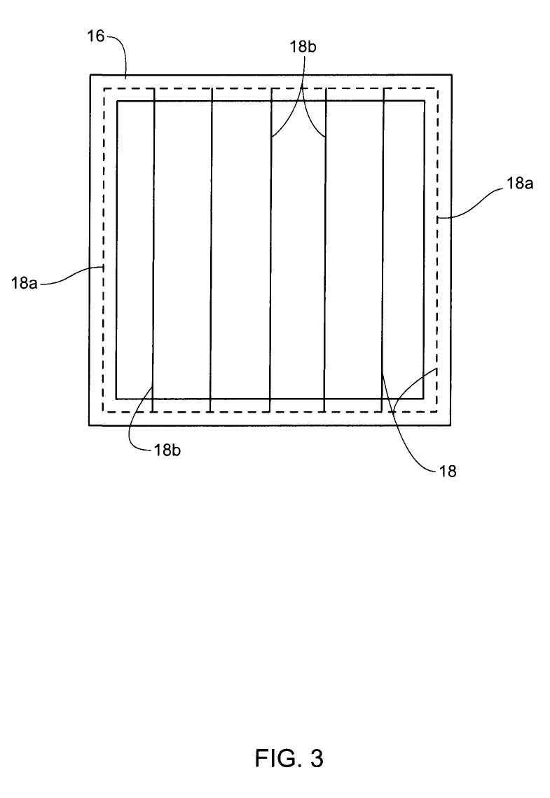

Referring also to FIG. 3, a wire frame 18 may be disposed at least partially within the tuck frame 16. The wire frame 18 may be configured to support the plurality of pockets 14 of the filter media insert 12. For example, the wire frame 18 may include a perimeter wire 18a and parallel support wires 18b. The perimeter wire 18a may be configured to rest on and/or be inserted into the tuck frame 16. The wire frame 18 may be constructed from galvanized steel or any other material of suitable strength to support the pockets 14 of the filter media insert 12. The filter media insert 12 may be inserted into the wire frame 18 after the wire frame 18 is inserted into the tuck frame 16. The pockets 14 of the filter media insert 12 may be inserted in between each of the parallel support wires 18b of the wire frame 18 such that the parallel support wires 18b provide support to the pockets 14 by supporting the filter media insert 12 in between each pocket 14 and preventing the pockets 14 from collapsing.

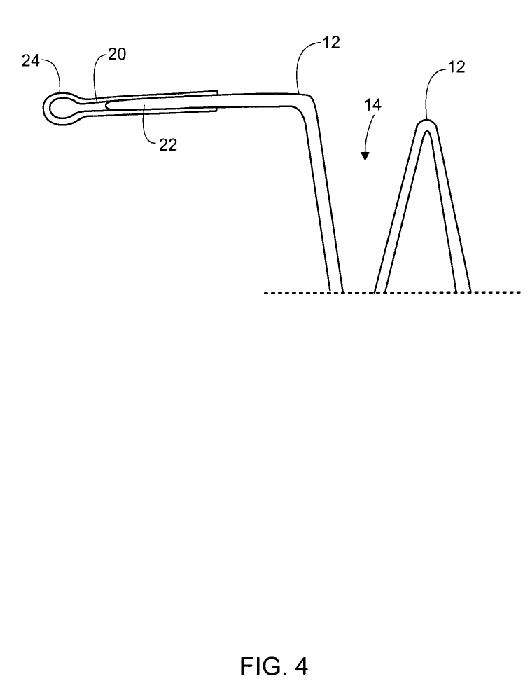

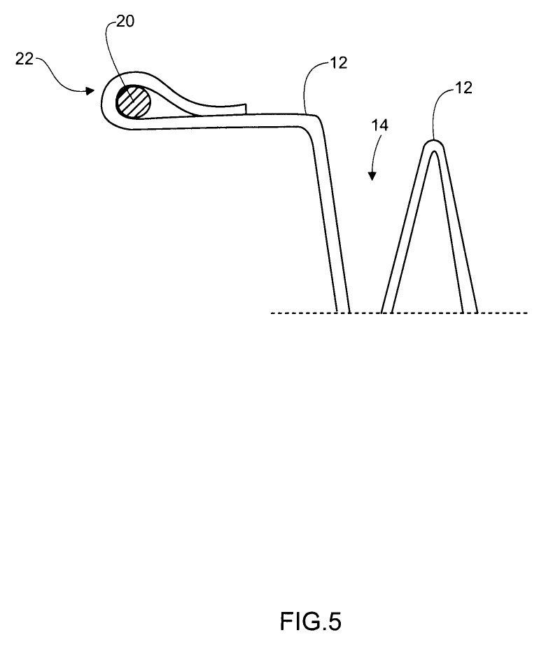

Referring also to FIG. 4, a hem seal 20 may be attached to the edge or a perimeter 22 of the filter media insert 12. The hem seal 20 may be formed from an extruded or molded plastic, such as flexible polyvinyl chloride, or any other suitable material. The hem seal 20 may be attached to the perimeter 22 of the filter media insert 12 by any suitable means, for example, as shown in FIG. 4, by heat sealing or stitching the hem seal 20 material directly to the filter media insert 12 material. Alternatively, referring also to FIG. 5, the hem seal 20 may be attached to the edge or perimeter 22 of the filter media insert 12 by including it within the edge or perimeter 22. For example, the hem seal 20 may be formed from a flexible and/or compressible rubber gasket material, which may be hemmed into the edge or perimeter 22 of the filter media insert 12 by, for example, stitching or heat sealing the perimeter 22 of the filter media insert 12 around the rubber gasket material. The flexible and/or compressible rubber gasket material may have a bulbous or circular shape and may be either solid or tubular.

The hem seal 20 may be configured for releasable engagement with the tuck frame 16. For example, the hem seal 20 may assist in securing the perimeter 22 of the filter media insert 12 in the tuck frame 16 by providing friction and/or a seal between the hem seal 20 material and the tuck frame 16 material. The hem seal 20 may be constructed in a shape and size suitable for insertion in and removal from the tuck frame 16. For example, the tuck frame 16 may include channel 26 having tabs 28 and 30 for securing the filter media insert 12. The hem seal 20 may be constructed in a shape and size small enough to fit into channel 26 but large enough to be held in place in channel 26 by tabs 28 and 30 once inserted.

Continuing with the above example, the hem seal 20 may be configured for releasable engagement with the tuck frame 16. For example, the hem seal 20 may be configured to collapse to facilitate the releasable engagement of the hem seal 20 with the tuck frame 16. The hem seal 20 may return to an uncollapsed configuration once engaged in the tuck frame 16. For example, the hem seal 20 may include a bulbous or circular engagement portion 24. As discussed above, the hem seal may be constructed from a flexible material, such as flexible polyvinyl chloride, which may retain memory of its molded or extruded shape. The engagement portion 24 of the hem seal 20 may be collapsed for insertion into the tuck frame 16, for example, into channel 26. Similarly, if the hem seal 20 is formed from a flexible and/or compressible material, the entire hem seal 20 may be compressed for insertion into channel 26 of the tuck frame 16. After insertion, the hem seal 20 and/or engagement portion 24 of the hem seal 20 may return to its bulbous or circular shape, enabling the perimeter 22 of the filter media insert 12 to fit and stay securely within the tuck frame 16. For example, the hem seal 20 and/or engagement portion 24 of the hem seal 20 may be of sufficient size and shape to fit into channel 26 and be held in place in channel 26 by tabs 28 and 30 once the hem seal 20 and/or the engagement portion 24 has expanded or returned to its bulbous shape.

The hem seal 20 may be configured to form a seal with the tuck frame 16. Using a flexible material to form the hem seal 20 may enable a close fit between the hem seal 20 and the tuck frame 16. For example, by using a material such as flexible polyvinyl chloride to make the hem seal 20, the hem seal 20 may grip or adhere to the tuck frame 16, providing both a barrier to the passage of particulates being filtered as well as securing the filter media insert 12 in place.

The tuck frame 16 may include the first channel 26 configured to accept the hem seal 20 and a second channel 32 configured to accept the wire frame 18. As discussed above, the first channel 26 may include tabs 28 and 30 configured to assist in securing the filter media insert 12 and/or the hem seal 20 in the tuck frame 16. The second channel 32 may be disposed adjacent to the first channel 26 such that, when inserted in the tuck frame 16 and wire frame 18, the filter media insert 12 is disposed above the wire frame 18.

The tuck frame 16 may be mounted in the support frame (not shown) of the filtration system by any suitable means. For example, the tuck frame 16 may be mechanically mounted by mechanical fasteners such as screws, nails, clips or clamps. Further, the tuck frame may be adhesively mounted by an adhesive layer 34 such as double-sided tape, double-sided foam tape or glue. Using an adhesive layer 34 may provide more uniform mounting in the support frame while also preventing damage to the support frame. Additionally, using an adhesive would not require any deformation or modification of the support frame, such as holes that might be required with mechanical fasteners, which would help maintain efficiency and help ensure that particulate matter does not escape the filtration system. In that way, the adhesive may double as a sealing mechanism, though other sealing mechanisms may be utilized as alternatives to or in addition to an adhesive. For example, a bead of caulk may be applied to the tuck frame 16 and the support frame to provide a seal, acting as a barrier to the passage of particulate matter.

The tuck frame 16 may be releasably mounted in the support frame (not shown) of the filtration system. For example, whether the tuck frame 16 is mounted using mechanical fasteners, such as screws or clips, or using an adhesive layer 34, the tuck frame 16 may be mounted in the support frame by non-permanent means such that the tuck frame 16 may be removed. The tuck frame 16 may be either reusable or replaceable. For example, if the tuck frame 16 is releasably mounted, it may be removed if damaged or worn and replaced with a new tuck frame 16. Similarly, the tuck frame 16 may be removed for reasons such as repair and/or cleaning and it may subsequently be reinstalled and reused.

It is to be understood that the foregoing description is intended to illustrate and not to limit the scope of the invention, which is defined by the scope of the appended claims. Other embodiments are within the scope of the following claims. For example, while the bag filter system 10 has been generally discussed as used in a paint overspray collection system, the bag filter system may also be configured for use in a heating system, a ventilation system, and/or an air conditioning system. Additionally, while the tuck frame has been discussed and illustrated as having two channels, the tuck frame may have only one channel configured to accommodate both the hem seal and the wire frame. Similarly, while the wire frame has been discussed as being removable from the tuck frame, alternatively, the wire frame may be permanently installed in the tuck frame. Further, while the hem seal has been discussed as having a bulbous expansion portion configured to collapse for insertion in the tuck frame, alternatively, a compressible insert may be included in the hem seal to facilitate engagement in the tuck frame.

What is claimed is:

1. A bag filter system comprising:
a filter media insert including a plurality of pockets;
a tuck frame configured for mounting in a support frame of a filtration system, the tuck frame further configured to releasably engage at least a portion of the filter media insert; and
a wire frame disposed at least partially within the tuck frame, wherein the wire frame is configured to support the plurality of pockets of the filter media insert.

2. The bag filter system of claim 1, wherein a hem seal is attached to a perimeter of the filter media insert, the hem seal configured for releasable engagement with the tuck frame.

3. The bag filter system of claim 2, wherein the tuck frame includes a first channel configured to accept the hem seal and a second channel configured to accept the wire frame.

4. The bag filter system of claim 2, wherein the hem seal is configured to form a seal with the tuck frame.

5. The bag filter system of claim 2, wherein the hem seal is stitched to the filter media insert.

6. The bag filter system of claim 2, wherein the hem seal is hemmed into the filter media insert.

7. The bag filter system of claim 2, wherein the hem seal is configured to collapse to facilitate the releasable engagement of the hem seal with the tuck frame, the hem seal returning to an uncollapsed configuration once engaged in the tuck frame.

8. The bag filter system of claim 1, wherein the tuck frame is mounted in the support frame of the filtration system by an adhesive.

9. The bag filter system of claim 1, further comprising a sealing mechanism configured to provide a seal between the tuck frame and the support frame.

10. The bag filter system of claim 9, wherein the sealing mechanism is an adhesive member.

11. The bag filter system of claim 1, wherein the tuck frame is releasably mounted in the support frame of the filtration system.

12. The bag filter system of claim 1, wherein the filter media insert is disposable.

13. The bag filter system of claim 1, wherein the bag filter system is configured for use in one or more of a paint overspray collection system, a heating system, a ventilation system, and an air conditioning system.

14. The bag filter system of claim 1, wherein the tuck frame is one or more of reusable and replaceable.

15. The bag filter system of claim 1, wherein the tuck frame is formed by extrusion.
